(19) United States
(12) Patent Application Publication
(10) Pub. No.: US 2019/0080330 A1
(43) Pub. Date: Mar. 14, 2019

(54) BIOMETRIC-BASED TRANSACTION AUTHENTICATION SYSTEM

(71) Applicant: Infinacom, LLC, Boston, MA (US)

(72) Inventor: Francisco Schipperheijn, Edmonton (CA)

(21) Appl. No.: 16/126,191

(22) Filed: Sep. 10, 2018

Related U.S. Application Data
(60) Provisional application No. 62/555,965, filed on Sep. 8, 2017.

(51) Int. Cl. G06Q 20/40; H04L 29/06; H04L 9/32; G06Q 20/12

(52) U.S. Cl. CPC G06Q 20/40145; H04L 63/0861; H04L 9/3228; G06F 17/30091; G06Q 20/12; G06Q 20/409; H04L 9/3231

(57) ABSTRACT

A transaction authentication center is electronically linked with a plurality of customers and retail merchants. During registration, the center issues and exclusively maintains an electronic transaction card for each customer. In addition, the center receives and fragments a reference biometric sample, provided by the customer, into multiple data files that are stored separately for optimal security. In use, when a customer initiates a financial transaction through an e-commerce platform on a merchant server, the server transmits an authentication request to the center. In response, the center requests a single-use biometric sample from the customer. Once received, the center compares the sample against the data files for the fragmented reference sample. If the samples match, the center authenticates the transaction and automatically enters the electronic card data for the customer into the designated transaction interface on the e-commerce platform, thereby streamlining transaction processing and limiting access to sensitive card data.

### FIELD OF THE INVENTION

The present invention relates generally to electronic financial transactions and, more particularly, to methods for authenticating a consumer engaged in an electronic financial transaction.

### BACKGROUND OF THE INVENTION

The number of commercial transactions conducted electronically (e.g. via the internet) has increased at a precipitous rate. In particular, online consumers routinely shop on e-commerce sites hosted by retail merchants. As part of the shopping experience, the customer selects certain goods and/or services to purchase. To execute the sale, the consumer and the retail merchant engage in an electronic financial transaction.

As defined herein, an electronic financial transaction encompasses any sale or purchase conducted over computer-mediated networks, including both online and mobile environments. Most commonly, electronic financial transactions are processed with assistance from third party credit or banking services.

The use of bank cards and credit cards in electronic financial transactions has introduced a notable drawback. Specifically, the proliferation of e-commerce has created a commensurate increase in the frequency of electronic financial transactions. By virtue of its repeated transmission across electronic networks, highly sensitive card information provided in electronic financial transactions has become increasingly available to certain unauthorized parties. As a result, card data obtained by unscrupulous individuals is often fraudulently utilized to engage in unauthorized financial transactions, frequently unbeknownst to the card owner.

To minimize the risk of card theft and transaction fraud, conventional transaction cards are often implemented with a unique identification, or security, code that is secretly maintained by the card owner. A personal identification number (PIN) and a cardholder verification value (CVV) are two types of security codes that are most commonly utilized with transaction cards.

Nonetheless, unscrupulous individuals often engage in surreptitious activities in an effort to obtain transaction card security codes and, once acquired, engage in fraudulent transactions. Well-known techniques for stealing transaction card security codes include, but are not limited to, password use surveillance, transaction card skimming, phishing scams, and wireless capture.

As a result, an increasing number of transaction cards is incorporated with a biometric sensor that is adapted to capture a unique biological attribute of the card owner, such as a fingerprint, voiceprint and/or facial attribute. An example of a transaction card with a biometric sensor is described in U.S. Pat. No. 7,480,637, to D. Kozlay (hereinafter Kozlay), the disclosure of which is incorporated herein by reference.

When processing a financial transaction using a biometric-type transaction card, a retail merchant authenticates card ownership by requiring the card user to submit a biometric sample (e.g. a fingerprint) using a local biometric sensor. If the biometric sample matches the biometric data stored on the card, the financial transaction is processed. However, if the biometric sample does not match the biometric data stored on the card, the financial transaction is denied.

Despite the numerous safeguards implemented to combat transaction card fraud, it has been found that unauthorized card activity remains prevalent, particularly in electronic financial transactions, since electronic transactions do not require the physical presence of the purchasing party before the selling party. Most notably, the electronic storage and transmission of biometric data files renders such data susceptible to capture by unscrupulous individuals. Unlike a PIN code, which can be changed by the card owner if compromised, a biometric sample is largely unmodifiable. For this reason, the theft of biometric data obtained through electronic financial transactions poses an even greater threat to the security of future transaction card use.

### SUMMARY OF THE INVENTION

It is an object of the present invention to provide a new and improved system for authenticating electronic financial transactions.

It is another object of the present invention to provide a transaction authentication system as referenced above that utilizes biometric data to minimize the risk of transaction card fraud.

It is yet another object of the present invention to provide a transaction authentication system as referenced above that protects biometric data from theft and subsequent fraudulent use.

It is still another object of the present invention to provide a transaction authentication system as referenced above that is inexpensive to implement, readily scalable, convenient to use, and highly effective in minimizing the risk of transaction card fraud.

Accordingly, as a feature of the invention, there is provided a system for authenticating an electronic financial transaction engaged between a customer and a retail merchant, the system comprising (a) a server hosted by the retail merchant, the server supporting an e-commerce platform, (b) a compute device adapted for use by the customer, the compute device being in electronic communication with the server, the compute device initiating the electronic financial transaction through the e-commerce platform, and (c) a transaction authentication center for authenticating the electronic financial transaction engaged between the customer and the retail merchant, the transaction authentication center comprising a central controller in electronic communication with the compute device and the server, (d) wherein the central controller is adapted to receive a first biometric sample for electronic transaction authentication, the processor receiving the first biometric sample from the customer via the compute device, the processor fragmenting the first biometric sample into first and second sets of data files, the first set of data files being stored on the compute device and the second set of data files being stored within the transaction authentication center.

As another feature of the invention, there is provided a method for authenticating an electronic financial transaction engaged between a customer and a retail merchant, the retail merchant hosting a server that supports an e-commerce platform, the method comprising the steps of (a) fragmenting a first biometric sample provided by the customer into first and second sets of data files, (b) initiating an electronic financial transaction on the e-commerce platform by the customer using a compute device in communication with the server, (c) in response to the initiation step, electronically transmitting an authentication query from the server to a central controller at a transaction authentication center, (d) after the authentication query step, providing a second biometric sample to the central controller from the customer via the compute device, and (e) comparing by the central controller of the second biometric sample against the first and second sets of data files in order to determine whether to authenticate the electronic financial transaction.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a simplified schematic representation of a transaction authentication system constructed according to the teachings of the present invention;

FIG. 2 is a top plan view of the biometric transaction card shown in FIG. 1;

FIGS. 3(a), 3(b) and 3(c) are illustrative biometric samples in the form of a fingerprint, facial recognition image, and voiceprint, respectively, the samples being depicted as fragmented to illustrate a novel component of the transaction authentication system shown in FIG. 1;

FIG. 4 is a sample database structure for data compiled by the data storage device shown in FIG. 1, the database structure being useful in understanding the operation of the transaction authentication center within the transaction authentication system;

FIG. 5 is a flow chart depicting a method by which a customer electronically registers with the transaction authentication center shown in FIG. 1; and

FIG. 6 is a flow chart depicting a method by which the transaction authentication center shown in FIG. 1 authenticates a customer engaged in an electronic financial transaction with a retail merchant.

### DETAILED DESCRIPTION OF THE INVENTION

### Transaction Authentication System 11

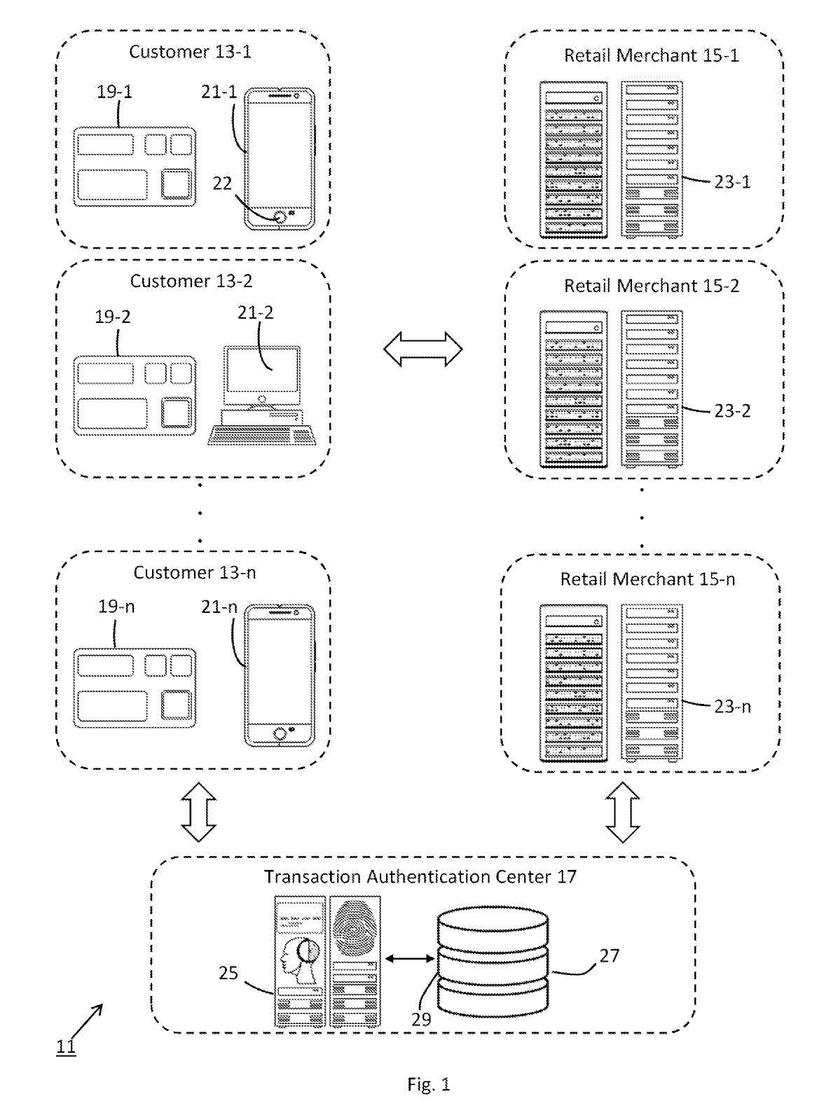

Referring now to FIG. 1, there is shown a simplified schematic representation of a transaction authentication system constructed according to the teachings of the present invention, the system being defined generally by reference numeral 11. As will be explained in detail below, system 11 utilizes biometric data to authenticate financial transactions. As a principal feature of the present invention, system 11 is designed to fragment and separately store biometric samples used in electronic financial transactions, thereby resulting in an enhanced level of data security.

As defined herein, the term “biometric” denotes any unique biological attribute of an individual that can be electronically captured and stored. For illustrative purposes only, biometric data is described herein as a fingerprint, voiceprint and/or facial attribute. However, it is to be understood that other types of biometric data could be utilized in system 11 for authentication purposes without departing from the spirit of the present invention.

As can be seen, transaction authentication system 11 comprises a plurality of customers 13-1 thru 13-n and a plurality of retail merchants 15-1 thru 15-n. As part of routine commercial activity, such as the sale of goods and/or services, each customer 13 is adapted to engage in a financial transaction with each retail merchant 15. When engaged in such commercial activity, system 11 requires a customer 13 to supply biometric data to verify authenticity (i.e. to prevent card fraud).

As a principal feature of the present invention, system 11 additionally comprises a transaction authentication center 17 in electronic communication with each of customers 13 and 15. As will be explained further below, transaction authentication center 17 is responsible for, inter alia, conducting a biometric-based verification of a customer 13 when engaged in an electronic financial transaction with a retail merchant 15. It is envisioned that transaction authentication center 17 could function as not only a transaction authentication service but also a financial institution, such as a bank or credit card company. However, it is to be understood that financial services could be alternatively provided to system 11 by one or more independent financial institutions without departing from the spirit of the present invention.

Customer 13 represents any individual engaged in commerce with one or more retail merchants 15. As a feature of the invention, system 11 utilizes a two-card solution to authentic financial transactions. Specifically, each customer 13 is issued (i) a physical biometric card 19 for in-person financial transactions (e.g. at a brick-and-mortar retail store) and a (ii) virtual biometric card for electronic-based financial transactions (e.g. with an online retail store). As will be explained further below, the virtual biometric card is stored primarily within transaction authentication center 17 and is accessed for use by a customer 13 during a financial transaction using a compute device 21. By maintaining the virtual biometric card within a highly secure environment (i.e. center 17), sensitive card data is less susceptible to theft, which is a principal object of the present invention.

Compute device 21 represents any type of device that (i) is adapted to engage in e-commerce through a designated webpage or mobile application, and (ii) integrally includes, or is able to peripherally support, a biometric sensor 22 (e.g., a fingerprint scanner, microphone or camera). For instance, compute device 21-1 is represented herein as smartphone with one or more integrated sensors 22, whereas compute device 21-2 is represented herein as a desktop computer that is configured to receive one or more biometric sensors as peripheral devices. However, it is to be understood that alternative types of compute devices which are known in the art, such as tablet or laptop computers, could be utilized in addition to or in place thereof without departing from the spirit of the present invention.

Retail merchant 15 represents any business entity that engages in commerce. For reasons to become apparent below, each retail merchant 15 is represented herein as a business engaged in e-commerce. At the same time, it is to be understood that retail merchant 15 could additionally operate as a traditional brick-and-mortar business. However, for reasons to become apparent below, an offline business would be incapable of implementing certain novel features of the present invention and, for this purpose, is not shown herein.

Each retail merchant 15 comprises a compute device 23 that is preferably designed to support the basic components and functions of an online store, such as product displays, a shopping cart and transaction card processing. For example, compute device 23 is represented herein as a server, locally or remotely located, that is programmed to host the e-commerce interface for retail merchant 15.

As noted briefly above, center 17 authenticates financial data utilized as part of an electronic financial transaction engaged between a customer 13 and a retail merchant 15. As shown herein, transaction authentication center 17 comprises a central controller 25 and a data storage device 27 in electronic communication with one another via network path 29. It is to be understood that central controller 25 and data storage device 27 may be housed at a common facility or remotely connected (e.g. as part of a cloud-based data storage solution).

As can be appreciated, central controller 25 performs the principal authentication process for an electronic financial transaction engaged between a customer 13 and a retail merchant 15. In the present embodiment, central controller 25 is shown as a server programmed to electronically communicate with each customer compute device 21 and each merchant server 23 through a designated network (e.g. via the internet).

Data storage device, or database, 27 represents any device that is designed to retrieve and store data. As will be explained further below, database 27 compiles not only data used to create a virtual biometric transaction card for each customer 13 but also platform information for each e-commerce merchant 15. In this capacity, center 17 is able to verify customer data using biometric information and, in turn, automatically execute an electronic financial transaction through the designated transaction processing interface for e-commerce merchant 15.

### Biometric Card 19 for In-Store Financial Transactions

As noted above, system 11 is uniquely designed to support both in-store financial transactions as well as electronic financial transactions in a highly reliable and secure fashion. To facilitate processing of in-store financial transactions, each customer 13-1 is preferably issued a physical biometric transaction card 19.

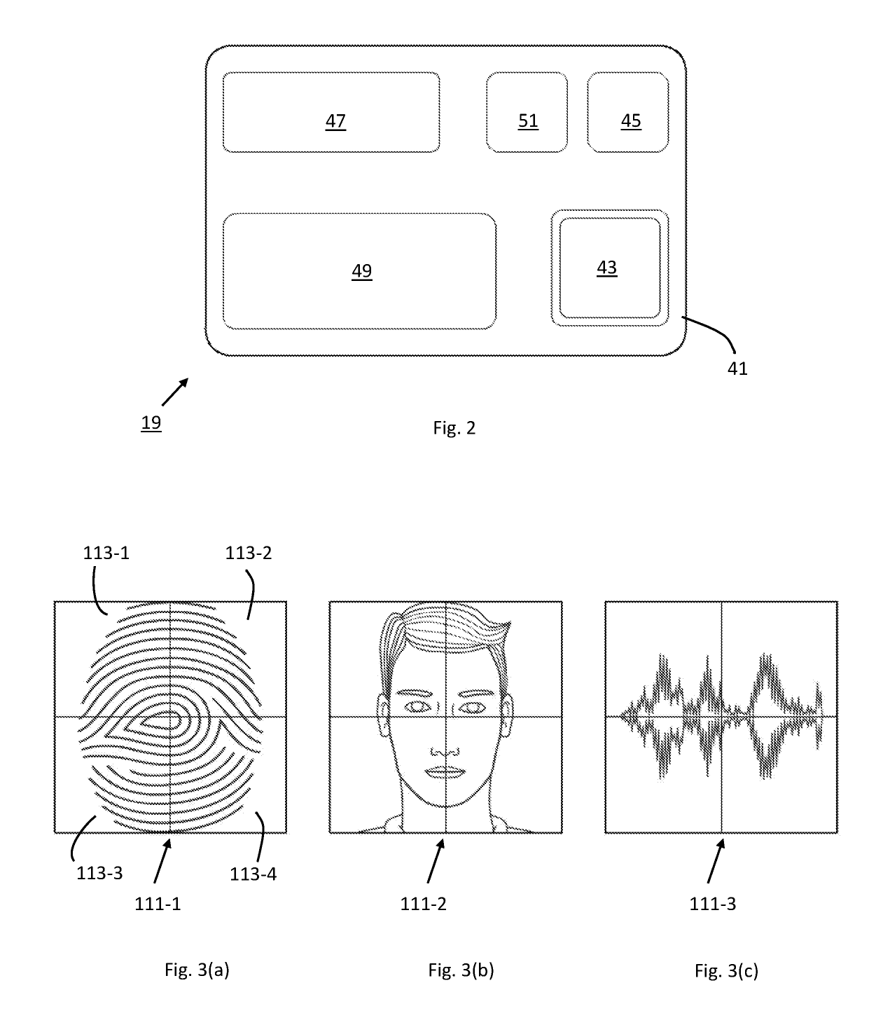

Referring now to FIG. 2, the details of biometric card 19 are shown. Card 19 preferably comprises a card body 41 constructed from one or more layers of a rigid and durable material, such as plastic. The dimensional aspects of card body 41 are preferably selected in compliance with industry standards.

Card 19 additionally includes a plurality of electrical components that are either mounted on or embedded within card body 41. Specifically, as shown herein, card 19 comprises a sensor 43 designed to electronically capture a biometric sample. For instance, biometric sensor 43 may be in the form of a fingerprint sensor array. However, it is to be understood that alternative types of biometric sensors could be used in place thereof without departing from the spirit of the present invention.

A main processor 45 is disposed in electrical communication with sensor 43 and is responsible for controlling the principal operations of card 19 including, but not limited to, storing a biometric sample collected from sensor 43 and initiating wireless transmission of the stored biometric sample via an antenna circuit 47. A power source 49, such as a battery, is provided to supply main processor 45 with the requisite operational power.

Accordingly, card 19 operates in a similar fashion to conventional biometric transaction cards (e.g. the biometric transaction card disclosed in Kozlay) in that a biometric sample stored on card 19 can be utilized to validate a card owner during in-store transactions. Specifically, using a biometric sensor in communication with the transaction terminal at the point-of-sale, a biometric sample is collected which is compared against the biometric data stored on main processor 45. If the biometric samples match, the card owner is considered verified and the financial transaction is processed. By contrast, if the biometric samples are not considered a match, the card owner is not considered verified and the financial transaction is denied.

Card 19 differs from traditional biometric transaction cards in that biometric transaction card 19 additionally includes an auxiliary processor 51 in communication with main processor 45. Auxiliary processor 51 is preferably programmed with algorithm-based artificial intelligence (Al) in an effort to render card 19 more secure. More particularly, processor 51 is adapted to receive additional customer-related data and/or analyze compiled biometric data in order to learn a dynamic set of information about customer 13 that can be used to improve authentication quality.

### Authentication Process for Electronic-Based Financial Transactions

As noted above, system 11 is uniquely designed to authenticate electronic financial transactions. In the description that follows, a detailed explanation is provided of how transaction authentication center 17 compiles biometric data and, in turn, utilizes such data to authenticate an electronic financial transaction engaged between a customer 13 and a retail merchant 15.

As a principal feature of the present invention, system 11 is designed to fragment an electronically-captured biometric sample into multiple, separate data files. In turn, the fragmented biometric data files are stored on separate devices within system 11. As can be appreciated, each biometric fragment, by itself, offers minimal value to individuals who partake in card fraud through the unauthorized capture of biometric data. Accordingly, by fragmenting the biometric samples used to authenticate financial transactions, system 11 is optimally configured to prevent potentially fraudulent activity.

For instance, in FIGS. 3(a), 3(b) and 3(c), there are shown illustrative biometric samples in the form of a fingerprint 111-1, a facial recognition image 111-2 and a voiceprint 111-3, respectively. As represented herein, each electronic biometric sample 111 is partitioned into multiple fragments, with each fragment stored as a separate data file.

As shown herein, fingerprint biometric sample 111-1 is fragmented into quadrants 113-1 thru 113-4, with each quadrant 113 represented as a separate data file. In turn, a selection of the fragmented data files 113 is stored in database 27. The remaining fragmented data files 113 are stored on the customer compute device 21.

It should be noted that the fragmentation of each biometric sample 111 is not limited to any particular arrangement or pattern. Rather, it is to be understood that the number and relative proportion of the individual biometric fragments could be modified without departing from the spirit of the present invention.

Using the stored biometric fragments, transaction authentication center 17 is able to (i) maintain a highly secure, virtual transaction card for each customer 13, (ii) authenticate use of the virtual transaction card through an encrypted biometric sample comparison process, and, when authenticated, (iii) automatically enter the virtual transaction card data into the dedicated transaction processing interface for e-commerce merchant 15, as will be explained in detail below. To facilitate the aforementioned tasks, transaction authentication center 17 preferably maintains all necessary data in an optimal arrangement within database 27.

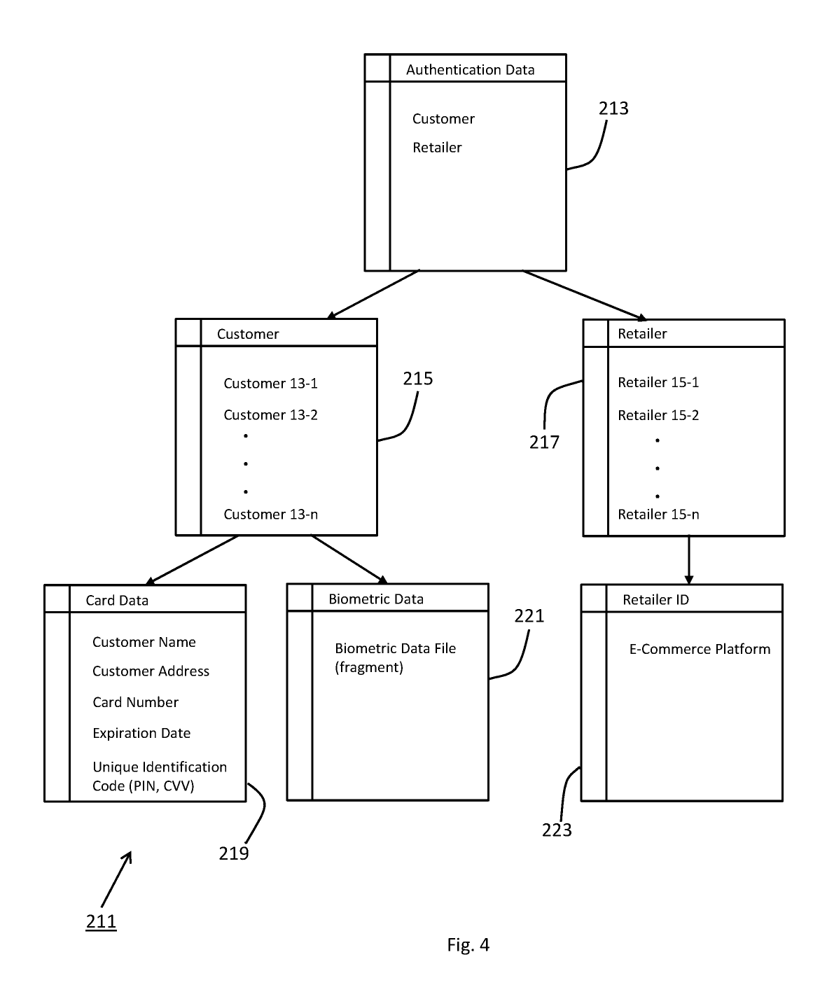

For instance, in FIG. 4, a sample data structure 211 for database 27 is shown. As can be seen, sample data structure 211 includes an arrangement of data tables that facilitates the principal responsibilities of transaction authentication center 17. Notably, sample data structure 211 comprises a main authentication table 213 that designates all participants within system 11. As can be seen, table 213 branches into a customer list table 215, which provides a list of all registered customers 13, and a retail merchant table 217, which provides a list of all participating merchants 15.

For each customer 13, database 27 compiles a card data table 219 and a biometric data table 221. Card data table 219 includes the primary transactional information needed to generate a virtual transaction card for each customer 13. For instance, card data table 219 includes, but is not limited to, (i) customer name, (ii) customer address, (iii) transaction card number, (iv) expiration date, and (v) unique identification code (e.g. a personal identification number (PIN) or cardholder verification value (CVV)).

Biometric data table 221 includes a set of data files for the one or more biometric sample fragments compiled for each customer 13. As previously referenced, transaction authentication center 17 is preferably maintained as a highly secure facility. Additionally, the biometric sample fragments stored in database 27 provide minimal value to any individual attempting to capture and use such data in any fraudulent activity. As a result, system 11 is able to verify and process electronic financial transactions in a highly secure fashion, which is a principal object of the present invention.

For each retail merchant 15, database 27 compiles an e-commerce platform table 223. As can be appreciated, table 223 maintains basic platform information for the transaction processing interface for each e-commerce merchant 15. Consequently, upon verifying customer 13, transaction authentication center 17 can auto-complete the necessary card data in the transaction processing interface for e-commerce merchant 15, thereby limiting electronic exposure (i.e. transmission) of highly sensitive transaction card data.

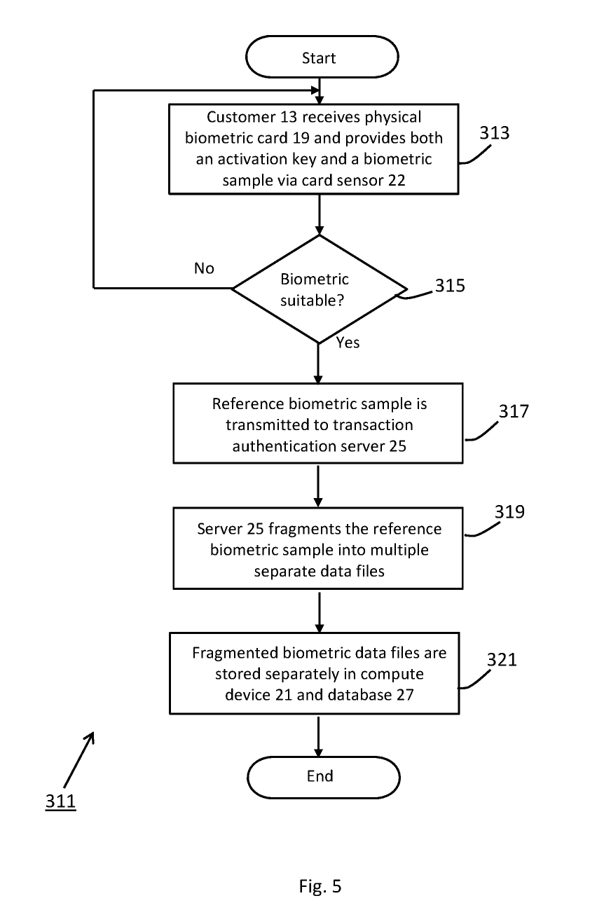

Using the basic architecture described above, system 11 can be used to authenticate electronic financial transactions in the following manner. Specifically, as a preliminary step in the authentication process, each customer 13 is required to register with transaction authentication center 17, the registration process being represented generally by reference numeral 311 in FIG. 5. Upon completion of the registration process 311, customer 13 is issued both a physical transaction card 19 and a virtual biometric transaction card that can be used in subsequent electronic financial transactions.

As a first step 313 in registration process 311, customer 13 receives physical biometric transaction card 19. For optimal safekeeping, customer 13 is preferably hand-delivered card 19 by visiting an authorized facility of center 17 (e.g. an affiliated financial institution). Upon immediate receipt of card 19, customer 13 preferably provides the first reference biometric sample via card sensor 22. As noted previously, this reference biometric sample is retained on card 19 is used in future commercial transactions, both in-store and electronic in nature, to verify customer 13 and minimize the risk of card fraud.

In lieu of in-person registration at an authorized facility of center 17, it is to be understood that transaction card 19 could be delivered by mail. In this situation, it is envisioned that card activation would be accomplished by providing the activation key as well as the reference biometric sample to center 17 during the first in-person use of card 19 (e.g. at a brick-and-mortar retail store).

In step 315, it is determined whether the reference biometric sample is suitable for use. If unsuitable, process 311 returns to step 313 and customer 13 is requested to submit a replacement biometric sample. If suitable for use, the reference biometric sample is retrieved from card 19 and transmitted to transaction authentication server 25 as part of step 317.

Thereafter, transaction authentication server 25 fragments the master reference biometric sample file into multiple separate data files, as represented by step 319. Subsequently, in step 321, a first set of the fragmented data files is stored in stored in database 27. Once the first set of master data files are stored, a virtual transaction card can be issued and exclusively maintained by transaction authentication center 17.

As an additional component of step 321, a second set of the fragmented data files is stored in a customer-designated compute device 21 for use in future electronic financial transactions. In other words, customer 13 links the designated compute device 21 with transaction authentication server 25 (e.g. by initiating a designated mobile application). Once the designated compute device 21 is verified (e.g. by providing a secondary biometric sample), the second set of fragmented data files is downloaded onto device 21.

For enhanced security and overall simplicity, it is envisioned that the activation of physical transaction card 19 (i.e. step 313) and the activation of the virtual transaction card (i.e. step 321) are accomplished through a one-time registration process undertaken at an authorized facility of center 17. In this manner, center 17 is ensured that card 19 is properly delivered to the rightful owner and that the second set of fragmented data files is stored on a user-verified device 21. However, it is envisioned that the aforementioned process could be accomplished in a difference sequence of steps without departing from the spirit of the present invention. Notably, if customer 13 needs to supplement or replace the user-designated compute device 21, customer 13 could simply revisit the authorized facility and download the second set of fragmented data files onto another device.

As a result of the aforementioned registration process 311, a minimal amount of data is actually retained on compute device 21. In fact, the only information stored on compute device 21 is the second set of fragmented data files, which, by itself, cannot be readily used for fraudulent activity. Instead, sensitive card data and the remaining fragmented data files are stored within transaction authentication center 17, resulting in more secure protection of sensitive card data.

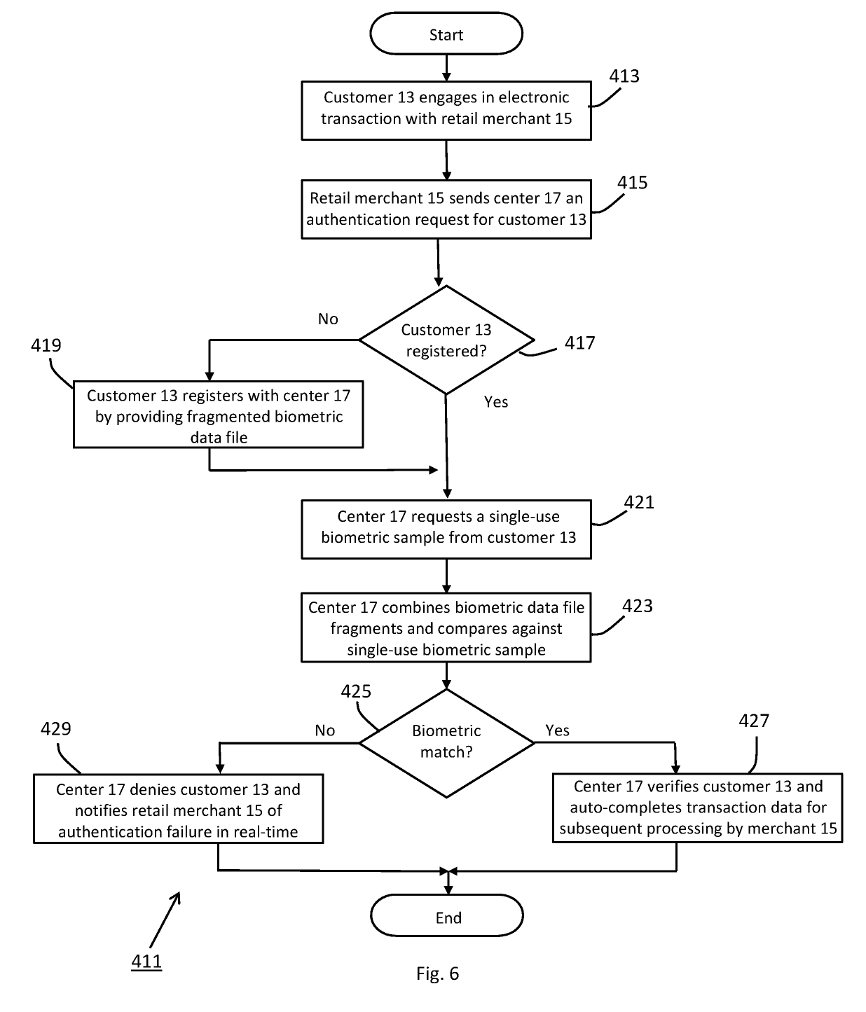

Upon completion of process 311, center 17 is properly prepared to authenticate an electronic financial transaction engaged between the registered customer 13 and a retail merchant 15. Referring now to FIG. 6, there is shown a flow chart depicting the step-by-step process by which center 17 authenticates an electronic financial transaction between a registered customer 13 and a retail merchant 15, the process being represented generally by reference numeral 411.

To commence process 411, a customer 13 engages in an electronic financial transaction with retail merchant 15, as represented by reference numeral 413. Most typically, transaction step 413 is initiated by customer 13 by visiting the e-commerce platform hosted by server 23, selecting products and/or services of interest, and then activating a checkout, or buy, button on the shopping page.

In response to the purchase request initiated by customer 13, retail merchant 15 sends a customer authentication query to center 17, the query step being represented by reference numeral 415. Upon receiving the query from merchant 15, transaction authentication server 25 first determines whether customer 13 is registered with center 17, as represented in step 417. Customer verification can be readily ascertained by cross-referencing customer list table 215 in database 27.

If customer 13 is not registered, server 25 sends a registration request directly to customer 13 via compute device 21. Thereafter, in step 419, customer 13 electronically registers with center 17 in the manner described in detail above as part of registration process 311. As referenced above, the registration process is responsible for, among other things, obtaining an electronic biometric sample, fragmenting the sample into first and second sets of data files, and, in turn, storing one of the sets of data files on a user-designated compute device 21 and the other of the sets of data files in database 27.

If/when customer 13 is registered, center 17 requires customer 13 to submit a single-use biometric sample via compute device 21 as part of step 421. In other words, customer 13 provides the requisite biometric sample using biometric sensor 22. Preferably, the single-use biometric sample is obtained through a vector-based imaging process. As can be appreciated, vectorizing the biometric sample improves the resultant signal-to-noise ratio, thereby resulting in a more robust data file.

For security purposes, the captured biometric sample is then encrypted and configured for one-time use. Once transmitted to server 25, the single-use biometric sample is then permanently deleted from compute device 21. As a result, the biometric sample is protected from any subsequent nefarious use (e.g. if retrieved by an unauthorized party).

In step 423, server 25 retrieves the first set of fragmented data files on customer compute device 21 and the second set of fragmented data files stored in database 27. Server 25 then temporarily merges the first and second sets of fragmented data files together to yield a merged biometric file. As part of step 425, transaction authentication server 25 compares the merged biometric file against the single-used biometric sample provided previously by customer 13 in step 421.

If transaction authentication server 25 determines a biometric match (i.e. verifying customer 13), server 25 retrieves virtual transaction card data for customer 13 from card data table 219. Additionally, as part of step 427, server 25 identifies the e-commerce platform characteristics for retail merchant 15 using platform table 219. In this manner, server 25 is able to automatically enter the requisite card data for customer 13 within the appropriate windows in the e-commerce transaction interface for retailer 15. As a result, the financial transaction can be promptly processed without exposing sensitive card data to transmission between entities.

By contrast, if transaction authentication server 25 determines an insufficient biometric match in step 425, server 25 denies the electronic financial transaction, as represented by reference numeral 429, and process 411 terminates. As part of transaction denial step 429, server 25 may send a real-time notification to customer 13 and/or merchant 15 of the authentication failure.

### Summary of Features and Advantages of Transaction Authentication System 11

As set forth in detail above, biometric-based transaction authentication system 11 provides a number of notable advantages over traditional card-based transactions.

As a first advantage, unfragmented, or complete, biometric data is never stored or maintained by any participant in system 11, thereby protecting highly sensitive biometric data from any unauthorized use. As referenced above, a reference biometric sample is fragmented into first and second sets of data files which are, in turn, stored separately between compute device 21 and database 27. Furthermore, the single-use biometric sample provided during an electronic financial transaction (i.e. for customer verification) is deleted from customer compute device 21 immediately after comparison against the first and second sets of biometric sample fragments. As a result, no device within system 11 ever stores, or otherwise retains, an unfragmented biometric file, which may be otherwise vulnerable to theft.

As a second advantage, by maintaining customer card data as well as e-commerce platform data, center 17 can automatically enter transaction card data into a retail merchant e-commerce shopping cart. Because sensitive card data (e.g. card number, expiration date or identification code) is never rendered accessible to customer 13 or merchant 15, the data is more effectively protected against the risk of theft. Additionally, the customer is never required to input transaction card data when engaged in electronic commerce, thereby resulting in a simpler, more streamlined shopping experience.

### System Enhancements and Design Modifications

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

In particular, it is envisioned that system 11 could be further expanded to support an artificial intelligence (Al) platform in order to (i) intelligently automate certain operations and (ii) enhance the overall security of cardholder data.

For instance, central controller 25 (or a separate designated server in communication therewith) is preferably programmed with an Al platform that (i) observes historical financial transactions engaged by customer 13 and, when appropriate, (ii) automatically executes future electronic financial transactions in compliance with customer-established rules, thereby simplifying user tasks. In this capacity, if a customer 13 routinely engages in an electronic financial transaction with a retail merchant 15 (e.g. the monthly payment of a utility bill), central controller 25 can recognize the transaction pattern and, in turn, support full/partial automation of future payments, if desired by customer 13.

As another example, the Al platform maintained by central controller 25 is programmed to compile additional customer-related information that can be used to further authenticate financial transactions. In other words, the Al platform maintains a selection of routines, each of which is designed to compile an additional piece of information that can be used to verify the customer. Examples of such information include, but are not limited to, (i) supplemental biometric data (e.g. a facial image used to supplement a fingerprint sample), and (ii) unique customer facts (e.g. city of birth, year of graduation, maiden name and the like).

By combining the supplemental information with the previously-captured biometric sample, an enhanced master customer profile can be generated to provide an even greater level of cardholder authentication security, which is highly desirable. Furthermore, because the supplemental information can be routinely updated and/or modified, as needed, the resultant master customer profile can continuously change. This dynamic aspect of the master customer profile maintained by center 17 significantly enhances authentication security and effectively renders system 11 impervious to fraudulent transactional activity.

As a result, it is envisioned that a binary-metric can be established which is calculated using elements of both (i) customer-related account data and (ii) an embedded serial number stored on auxiliary processor 51. This binary-metric is then stored in auxiliary processor 51 as a means to authenticate customer 13.

Additionally, a metric-key can be established that includes portions of the biometric sample provided by customer 13 as well as the binary-metric stored on card 19. As can be appreciated, the metric-key adds a second layer of protection to shield the biometric sample, with the fragmenting process referenced above being the first layer of protection.

What is claimed is:

1. A system for authenticating an electronic financial transaction engaged between a customer and a retail merchant, the system comprising:
(a) a server hosted by the retail merchant, the server supporting an e-commerce platform;
(b) a compute device adapted for use by the customer, the compute device being in electronic communication with the server, the compute device initiating the electronic financial transaction through the e-commerce platform; and
(c) a transaction authentication center for authenticating the electronic financial transaction engaged between the customer and the retail merchant, the transaction authentication center comprising a central controller in electronic communication with the compute device and the server;
(d) wherein the central controller is adapted to receive a first biometric sample for electronic transaction authentication, the processor receiving the first biometric sample from the customer via the compute device, the processor fragmenting the first biometric sample into first and second sets of data files, the first set of data files being stored on the compute device and the second set of data files being stored within the transaction authentication center.

2. The system as claimed in claim 1 wherein the transaction authentication center stores an electronic transaction card for the customer, the electronic transaction card comprising card data for electronic financial transactions.

3. The system as claimed in claim 2 wherein the transaction authentication center exclusively maintains the card data for the electronic transaction card.

4. The system as claimed in claim 2 wherein the transaction authentication center comprises a database, the second set of data files being stored in the database.

5. The system as claimed in claim 2 wherein the central controller receives a second biometric sample from the customer via the compute device.

6. The system as claimed in claim 5 wherein each of the first and second biometric samples is of the type from the group consisting of a fingerprint sample, a voiceprint sample and a facial recognition image sample.

7. The system as claimed in claim 5 wherein the central controller retrieves the first and second sets of data files and compares the first and second sets of data files against the second biometric sample.

8. The system as claimed in claim 7 wherein the central controller authenticates the electronic financial transaction if the second biometric sample matches the first and second sets of data files.

9. The system as claimed in claim 8 wherein the second biometric sample is encrypted for one-time use.

10. The system as claimed in claim 8 wherein, if the authentication biometric sample matches the first and second sets of data files, the central controller automatically enters the card data into a transaction interface on the e-commerce platform for processing of the electronic financial transaction.

11. A method for authenticating an electronic financial transaction engaged between a customer and a retail merchant, the retail merchant hosting a server that supports an e-commerce platform, the method comprising the steps of:
(a) fragmenting a first biometric sample provided by the customer into first and second sets of data files;
(b) initiating an electronic financial transaction on the e-commerce platform by the customer using a compute device in communication with the server;
(c) in response to the initiation step, electronically transmitting an authentication query from the server to a central controller at a transaction authentication center;
(d) after the authentication query step, providing a second biometric sample to the central controller from the customer via the compute device; and
(e) comparing by the central controller of the second biometric sample against the first and second sets of data files in order to determine whether to authenticate the electronic financial transaction.

12. The method as claimed in claim 11 wherein, as part of the comparing step, the central controller authenticates the electronic financial transaction by the central controller if the second biometric sample matches the first and second sets of data files.

13. The method as claimed in claim 12 further comprising the step of issuing an electronic transaction card for the customer that is maintained by the transaction authentication center, the electronic transaction card comprising card data for electronic financial transactions.

14. The method as claimed in claim 13 wherein the transaction authentication center exclusively maintains the card data for the electronic transaction card.

15. The method as claimed in claim 13 further comprising the step of electronically entering card data for the electronic transaction card by the central controller into a transaction interface on the e-commerce platform if the second biometric sample matches the first and second sets of data files.

16. The method as claimed in claim 13 wherein the first and second sets of data files generated in the fragmenting step are stored separately.

17. The method as claimed in claim 16 wherein the first set of data files is stored on the compute device and the second set of data files is stored at the transaction authentication center.
